(19) United States
(12) Patent Application Publication
(10) Pub. No.: US 2008/0154889 A1
(43) Pub. Date: Jun. 26, 2008

(54) VIDEO SEARCHING ENGINE AND METHODS

(76) Inventor: Silvia PFEIFFER, Ryde (AU)

Correspondence Address: Pearl Cohen Zedek Latzer, LLP, 1500 Broadway, 12th Floor, New York, NY, 10036, US

(21) Appl. No.: 11/961,298

(22) Filed: Dec. 20, 2007

(30) Foreign Application Priority Data
Dec. 22, 2006 (AU) 2006907163

(51) Int. Cl. G06F 17/30

(52) U.S. Cl. 707/5; 707/E17.108

(57) ABSTRACT

A video search system and method adapted to be queried by a user for accessing video data. The method comprising the steps of: providing an index containing a plurality of index data each indicative of one or more video data element accessible on a data network for defining a collection of the video data elements; receiving a user query from the user; matching the user query to one or more the index data defining a result set of index data; ranking the result set for defining a ranked result set of index data; generating a slicecast of video data elements indicative of the ranked result set; and presenting the slicecast to the user. A user interface adapted to present the slicecast of results preferably comprises a first current playlist video element area for playback of an extracted portion of a current playlist video item and a second list of playlist element area including a series of playlist videos for playback by a user.

### CROSS REFERENCE TO RELATED APPLICATIONS

This application claims priority from Australian Patent Application No. 2006/907163, filed on Dec. 22, 2006, which is incorporated herein by reference in its entirety.

### FIELD OF THE INVENTION

The present invention relates to the field of video searching and, in particular, discloses a video search engine and query interface for searching, interfacing with, and socialising a large amount of video materials. It also discloses methods of displaying advertisements in large amounts of video material.

### BACKGROUND OF THE INVENTION

Search engines for searching a large amount of electronic material have become increasingly important. In particular, search engines for searching the Internet have become an almost essential tool. The search engine principals have been applied to other environments such as library and hard disc searching. Search engines from Google, Microsoft, Yahoo etc normally operate by scouring the Internet for information.

The usual procedure in constructing a search engine is by the following steps:
1. Initially, a traversal of the Internet is conducted to locate a large number of documents. The documents are normally stored in a compressed format as part of this step, an initial expected document value is created.
2. Next, an “inverted index” is formed of the documents. The inverted index is normally by key words. For each keyword, a list of relevant documents is created as part of the inverted index.
3. A query interface is then provided. The interface provides for the entry of queries by a user. Subsequently, the query is “executed”.

For an example of a search engine, see: “The anatomy of a large-scale hypertextual Web search engine”, in Proceedings of WWW7, pages 107-117, 1998.

Unfortunately, applying the search engine techniques to video material is not simple. Video, by its nature, has different characteristics from the usual textural and image information that search engines usually index.

Further, the presentation of large volumes of video information is problematic in that an effective interface is required that encompasses advertising models and socialising of video selections. There is a need for the use of video search, advertisement, and socialisation has to be measured effectively to gain business-relevant information.

### SUMMARY OF THE INVENTION

It is an object of the present invention to provide for a video based search engine that provides for an improved searching experience.

According to a first aspect of the invention there is provided a video search method adapted to be queried by a user for accessing video data, the method comprising the steps of:
(a) providing an index containing a plurality of index data each indicative of one or more video data element accessible on a data network for defining a collection of the video data elements;
(b) receiving a user query from the user;
(c) matching the user query to one or more index data defining a result set of index data;
(d) ranking the result set for defining a ranked result set of index data;
(e) generating a slicecast of video data elements indicative of the ranked result set; and
(f) presenting the slicecast to the user.

Preferably, generating a slicecast includes the steps of
(a) creating for each video data element a video snippet of a predetermined length;
(b) ordering the video snippets into a first predetermined order associated with the ranked result set; and
(c) combining the ordered video snippets to form a slicecast.

Preferably, presenting the slicecast includes providing an interactive interface that includes the steps of:
(d) displaying a first section for images indicative of a predetermined number of the video snippets in the first predetermined order;
(e) displaying a second section for playing in turn the snippets from each of the video data elements indicative of the ranked result set.

The video snippets are preferably substantially 7 to 12 seconds long. The videos snippets are preferably displayed in a click-through format.

Preferably, the method further includes the step of providing a HTML insertable object having the rendering characteristics of
(a) displaying a first section for images indicative of a predetermined number of the video snippets in the first predetermined order; and
(b) displaying a second section for playing in turn the snippets from each of the video data elements indicative of the ranked result set.

The second section preferably plays a current video snippet, the first section displays images indicative of the video snippets before and after the current video snippet in the first predetermined order. The HTML insertable object preferably includes the slicecast. The slicecast is preferably in an XML format.

Preferably, the slicecast is pre-cached for presenting to the user. Generating the slicecast preferably includes inserting one or more advertising video elements. The videos elements preferably further include advertisements in the form of at least one of icons, bugs, banner, audio or video advertisements.

Providing an index preferably includes the steps of:
(a) providing an tag set;
(b) searching a video host site for video elements associated with tags in the tag set;
(c) indexing videos elements returned by the host site.

Providing an index preferably further including the steps of:
(d) interrogating video elements returned by the host site to identify additional tags associated with the video elements;
(e) adding additional tags to the tag set; and
(f) repeating steps (a) through (c).

Preferably, one or more advertising video elements are indexed.

Preferably, ranking the result set includes ranking the video data based on any one or more indicator selected from the set comprising: weighting the number of query terms that are included; weighting the relative location of query terms that are included; weighting the frequency of occurrence of query terms that are included; and weighting the functional location of query terms that are included.

Preferably, the index includes data indicative of any one or more videos and their metrics selected from the set comprising: view count; completeness count; average view duration; and click count.

Preferably, the index includes data indicative of any one or more videos and their metrics elected from the set comprising: multiplicity measurement; volume measurement; virality indicator; spread rank; geographical reach; controversy indicator; attractiveness indicator; relevance rank; and influence indicator.

According to a second aspect of the invention there is provided a video search system adapted to be queried by a user for access to videos, the system comprising:
an index indicative of collected video elements;
a user interface associated with the index for providing keyword searching capabilities; the user interface adapted to present a slicecast of results;
the user interface further comprising a first current playlist video element area for playback of an extracted portion of a current playlist video item and a second list of playlist element area including a series of playlist videos for playback by a user.

Preferably, the video search system further comprising a crawler adapted to retrieve and index video elements located on a data network. The crawler is preferably further adapted to iteratively retrieve data elements from a host site on the data network.

According to a third aspect of the invention there is provided a computer-readable carrier medium carrying a set of instructions that when executed by one or more processors cause the one or more processors to carry out a video search method adapted to be queried by a user for access to video data, the method comprising the steps of:
(a) providing an index containing a plurality of index data each indicative of one or more video data element accessible on a data network for defining a collection of video data elements;
(b) receiving a user query from the user;
(c) matching the user query to one or more the index data defining a result set of index data;
(d) ranking the result set for defining a ranked result set of index data;
(e) generating a slicecast of video data elements indicative of the ranked result set; and
(f) presenting the slicecast to the user.

In accordance with a further aspect of the present invention, there is provided a method of displaying a series of videos from a collection of videos, the method comprising the steps of: creating for each video a video snippet of a predetermined length; ordering the collection of snippets into a first predetermined order; providing an interactive interface that includes: a first section having a predetermined number of ordered videos laid out in the first predetermined order; and a second section for playing snippets from each of the videos in turn in the first predetermined order. We call such a composition a “slicecast”.

Preferably, the method further comprises providing a html insertable object having the rendering characteristics as previously set out and thus allowing embedding and socialising. The html insertable object includes a video playlist as a slicecast. The video slicecast is preferably provided in an XML format. Preferably, the slicecast is presented in two sections, where the first section plays a current video and the second section displays video snippets before and after the current video in the ordered list. The second section can further include at least one advertising video. The video snippets can be pre-cached for display. The snippets can be substantially 5-20 seconds long, preferably around 7 seconds. Ideally, the videos are displayed in a click through format. The sections can also include advertisements in the form of at least one of icons, bugs or banner advertisements.

In accordance with a further aspect of the present invention, there is provided a video search engine including: an index of collected video materials; a user interface to the index providing keyword searching capabilities and returning a playlist of likely results of interest, and the user interface further comprising a first current playlist video element area for playback of an extracted portion of a current playlist video item and a second list of playlist element area including a series of playlist videos for playback by a user.

### BRIEF DESCRIPTION OF THE DRAWINGS

Preferred forms of the present invention will now be described with reference to the accompanying drawings in which:

FIG. 1 illustrates schematically the operational portions of the preferred embodiment;

FIG. 1A is similar to FIG. 1 but includes an advertisement management system;

FIG. 2 illustrates a flowchart of the steps of the preferred embodiment;

FIG. 3 to FIG. 8 illustrates an example user interface;

FIG. 9 illustrates an example interaction analytics;

FIG. 10 illustrates an example video advertising user interface;

FIG. 11 illustrates an example tag crawling algorithm;

FIG. 12 illustrates an example Document Type Definition (DTD) specification for a persistent slicecasts; and

FIG. 13 illustrates an example XML file for representing one search result.

### DESCRIPTION OF THE PREFERRED AND OTHER EMBODIMENTS

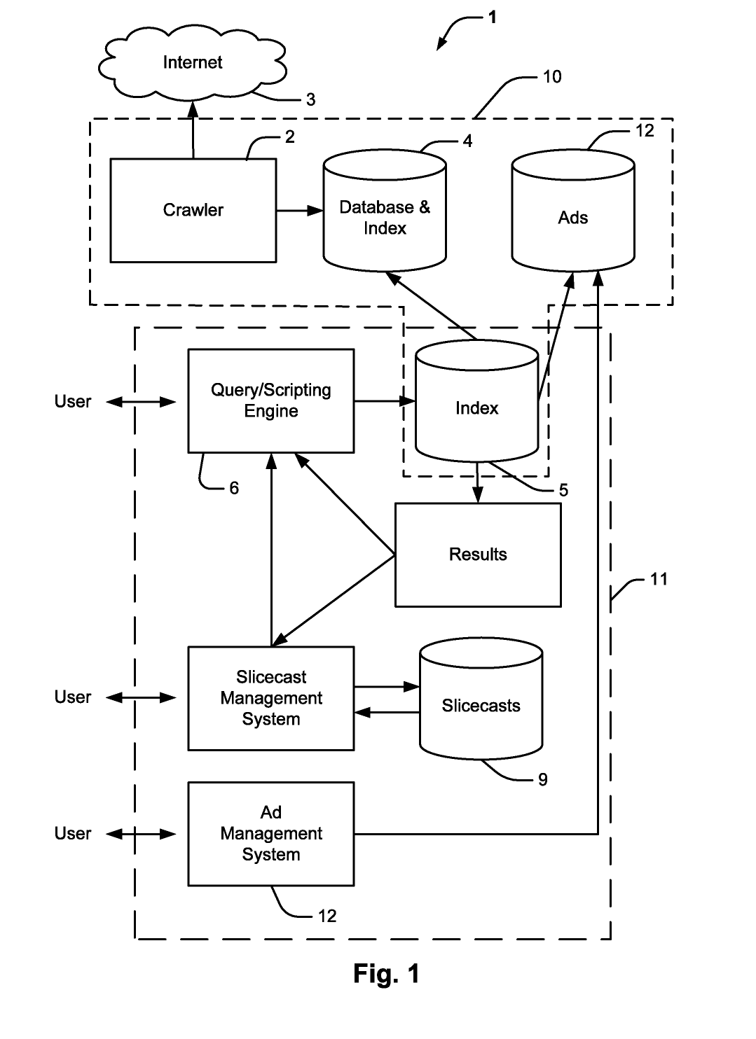

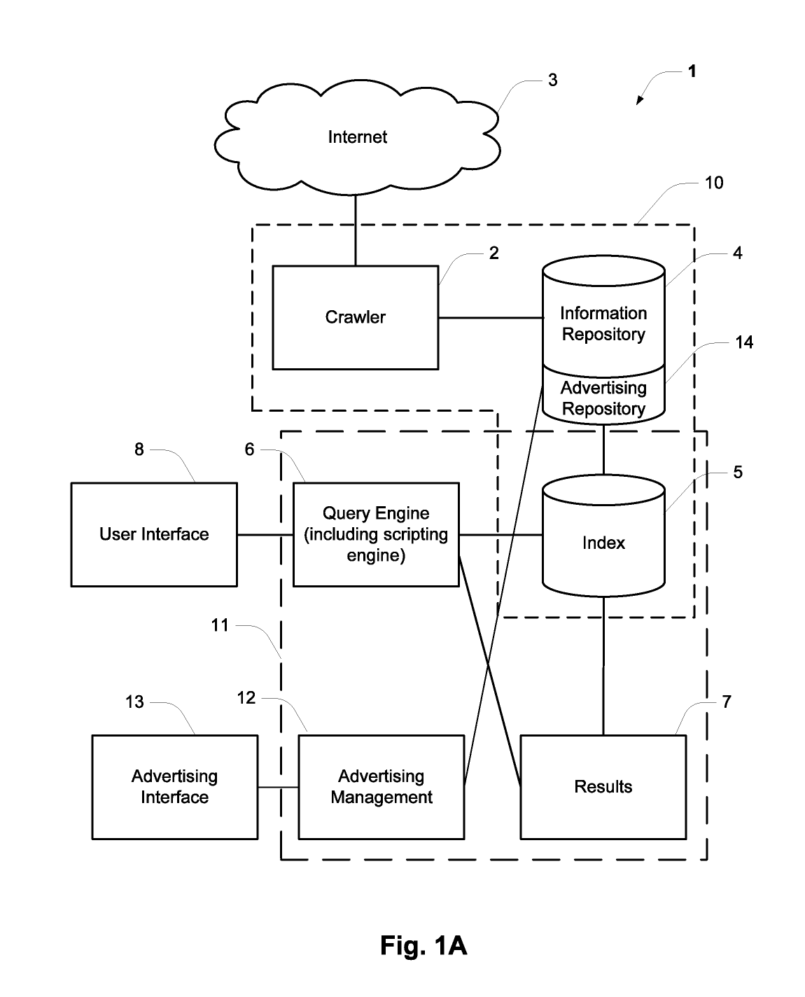

Referring to FIG. 1, a preferred embodiment comprises a video search system, which can be queried by a user for access to videos. A crawler 2 is adapted for crawling the Internet 3 looking for video material. It would be appreciated that the crawler can be adapted to look for video material on other similar video collection arrangements. An information repository (or database) 4 stores the material found by the crawler, which is later indexed to form an inverted index structure 5.

It would be appreciated that the components of a video search system can include a backend system 10 and a server system 11. The server system can include a web server, a server-side scripting engine, a server side media layer, and a server side player application. These components can be loosely grouped into an offline backend system 10 and online user-interaction server system 11.

A user interface 8 enables a user to interrogate a server-side query engine 6 with a query. This query is used to interrogate the index 5 to obtain a result set 7, which can be displayed to the user. The user interface 8 can further include a playlist management system that has the functionality of using search results, and other links to videos, to create playlists (or slicecasts) that can be stored on the server. In this example, the playlist management is part of the server-side scripting engine. A video player can also be provided, which allows embedding of playlists into other Websites.

Referring to FIG. 1A, an advertisement management system 12, which allows advertisement clients to submit advertisement material via an advertising interface 13, to be submitted to an system advertisement repository 14. Typically the advertising material is in the form of video data, and the advertising repository is included in the information repository 4. By including information indicative of the advertising material in the index 5, upon a user's query to the query engine, advertisements can also located in advertisement repository (or the information repository if incorporated together) for delivery as part of the results 7. Metrics can also be calculated from the video data, which can be related to their identified use and/or intended audience.

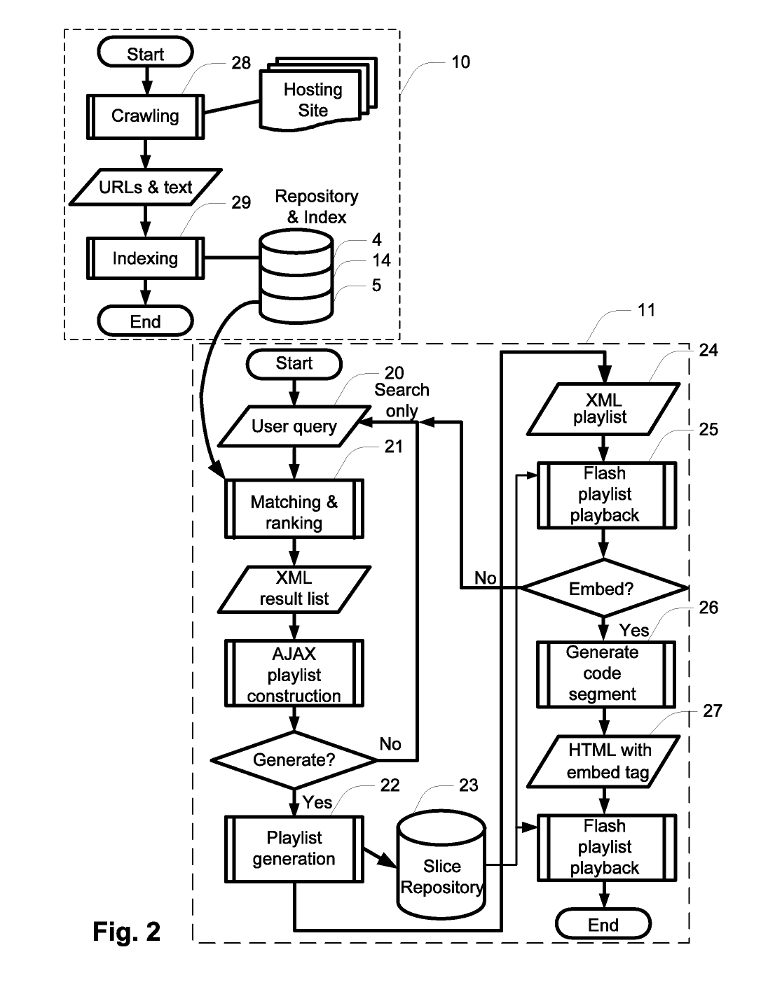

Referring to FIG. 2, an example flowchart of the overall processing sequence is illustrated.

This backend system 10 is required to create the index 5. The information from a crawler 28 is collected in the information repository 4. An indexer 29 then indexes this information to form the index 5. The backend system can also process the advertising material in the advertising repository 12. In this example, both of these repositories can form the basis for the index 5.

This server system 11 represents ability for user interaction. By way of example, a user can start with a user query 20, which is initiative of a search 21 on the index 5. This search returns a list of videos. From one or more results, a user can create a playlist (or slicecast) 22. These playlists can be created by selecting clips identified in the results, for example by dragging and dropping each clip. During this playlist (or slicecast) creation, the user can also select and include relevant advertisements or put a placeholder advertisement at certain places with the stream, which will be replaced in real-time as the server system comes across it. For example, the server system will come across a placeholder after the respective slicecast has been published. Publication of the slicecast can include being embedded into another webpage or just simply finished and stored in the slicecast collections.

In an embodiment, thin sliced video clips are downloaded from their original site and cached in a slice repository 23 at the time of crawling, and an XML playlist 24 is created, which can be played back in a specialised player. As a user decides to watch a playlist, using a GUI playlist playback software, a video player is downloaded to their computer and starts streaming the thin slices from the server according to the playlist. A HTML code segment can also be constructed and made available 26 to a user embedding a playlist in another HTML page 27.

In an embodiment, a backend system can comprise automatic identification of videos that have been duplicated within or between collections. Identification of duplication includes identification of reuse of all or part of a video track (a so-called video mash-up), all or part of an audio track (a so-called audio mash-up), or reuse of all or part of a video clip. Typical features that are useful for this analysis are colour histograms and image segmentation approaches. The back end system can preferably further comprise automatic identification of logos, jingles or similar identifying markers to improve search results. Typical features that are useful for this analysis are colour histograms and audio-visual segmentation approaches.

### User Experience

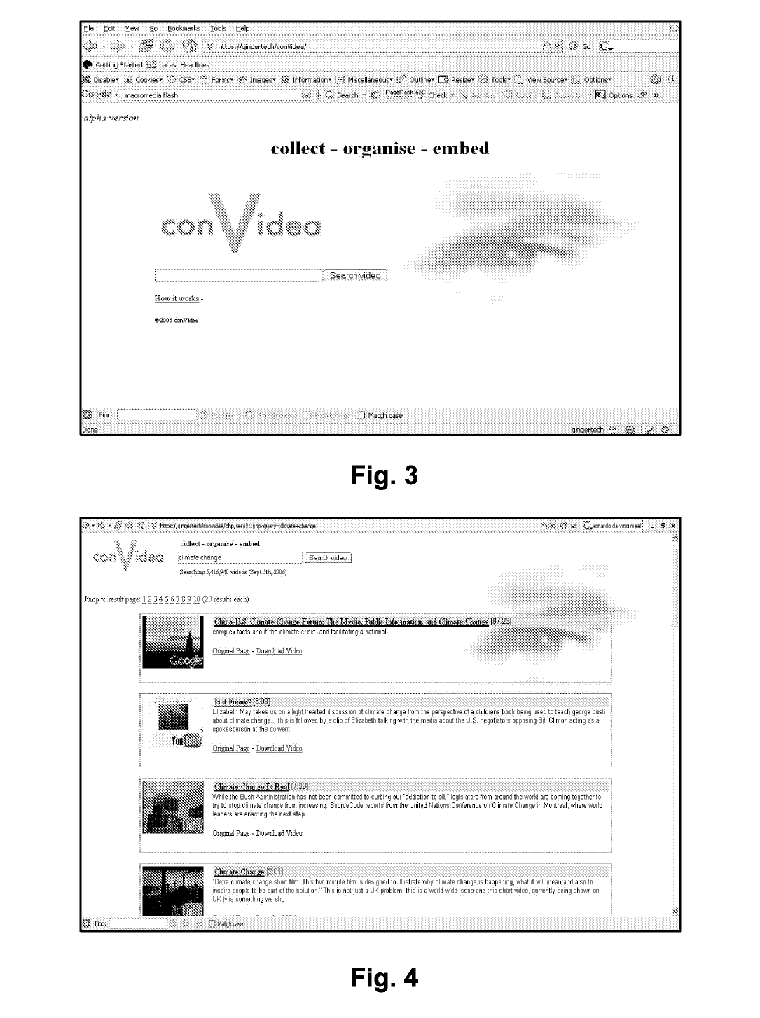

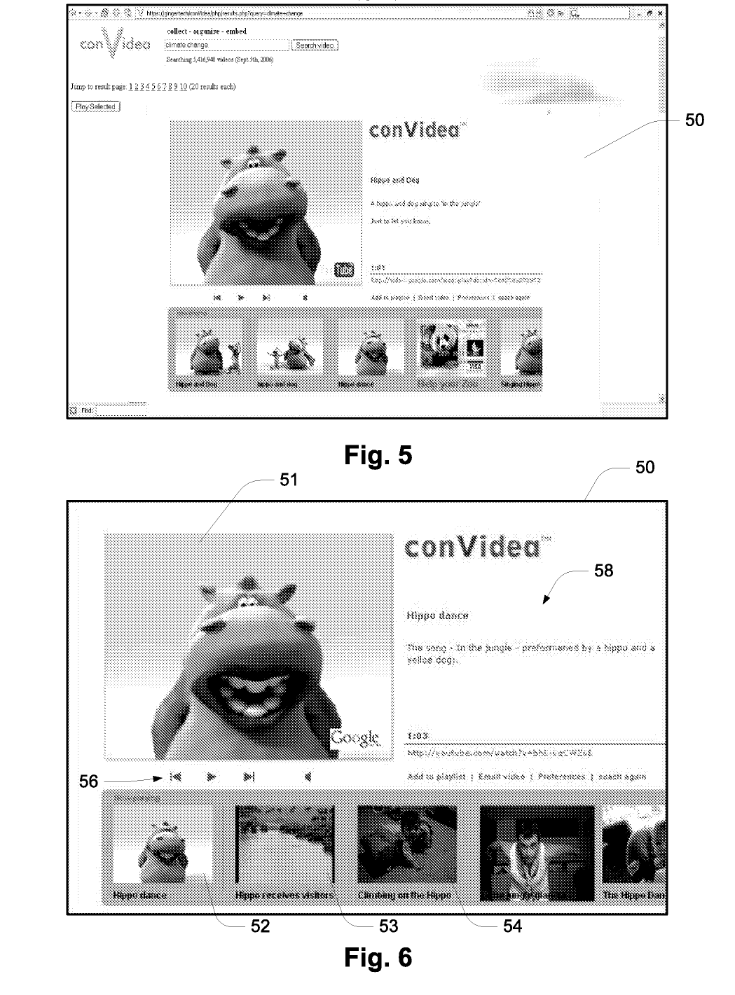

FIG. 3 through FIG. 7 illustrate some of the functionality of an example embodiment. FIG. 3 illustrates an initial simple entry screen for a user to enter keywords that form part of the query. Upon completion of a query, a series of ranked matches are presented to the user. FIG. 4 shows an example series of ranked matches that form a result. A playlist can be formed from selected matches within the result, as best shown in FIG. 5.

If a user selects to create a playlist or slicecast (“create slicecast”), the server creates a preview slicecast, which can be initially presented to the user as a message. It would be appreciated that while the preview is being created, the user can preferably continue to work with the user interface.

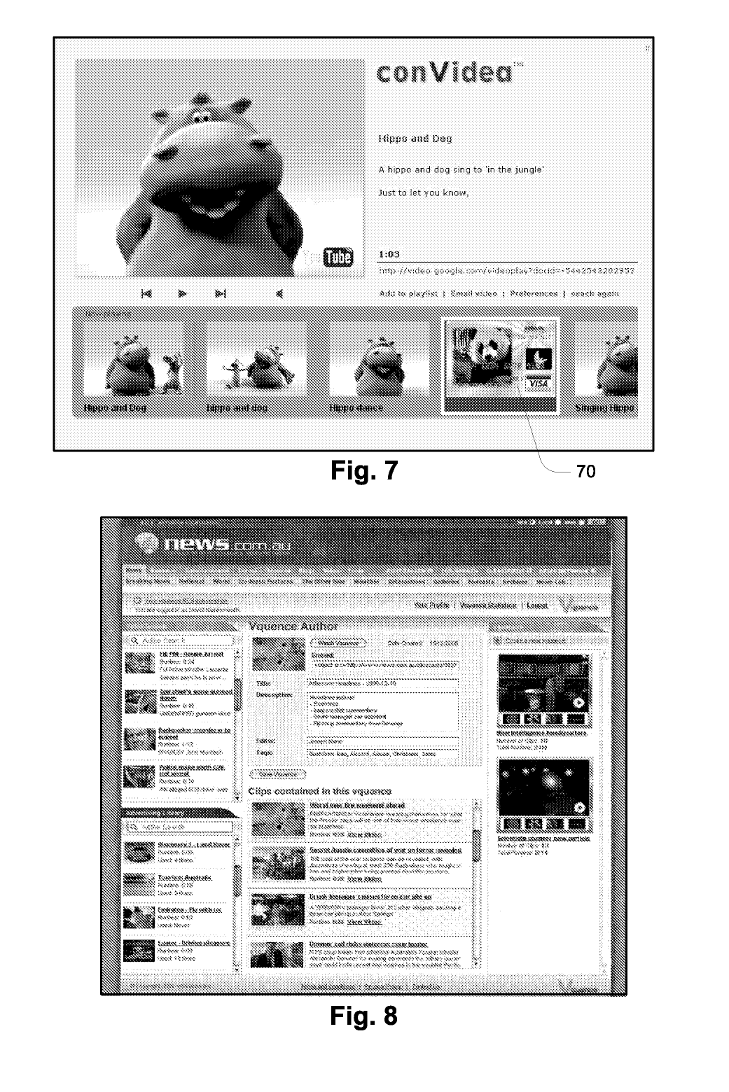

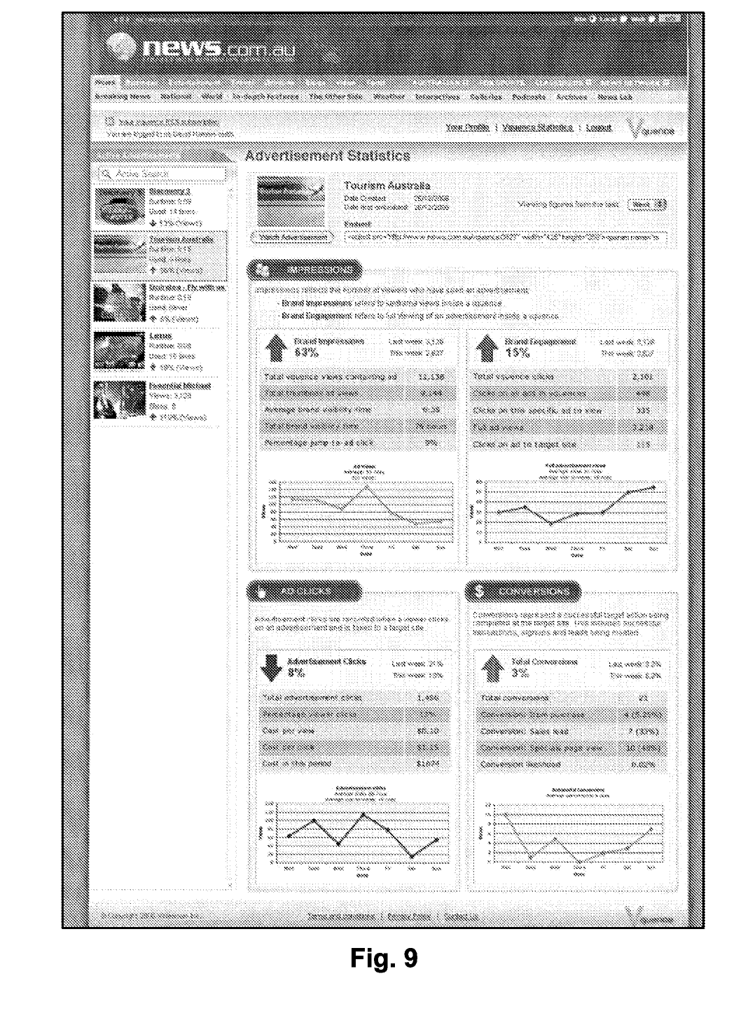

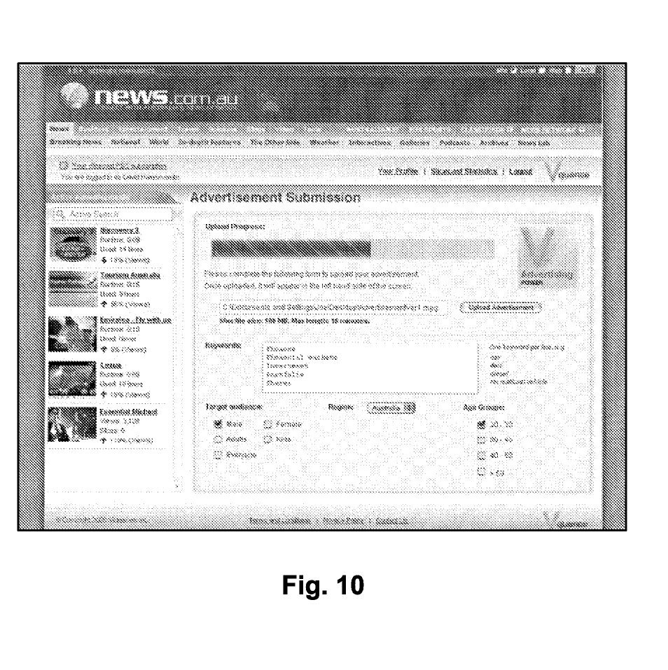

In an embodiment, by way of example only, once a slicecast is created, a user is notified that the playlist can be watched now. By selecting to play the playlist, the video player starts and provides a rich interface with the selected video clips. It would be appreciated that video advertisements can be inserted. FIG. 5 illustrates a playlist interface structure 50. FIG. 6 illustrates an enlarged version of the playlist interface structure 50 of FIG. 5. This playlist structure 50 includes a current video item 51 having associated video controls 56. A sequence of videos that come both before and after the current item in the search list can also be shown. Referring to FIG. 7, in some environments, the sequence of videos can include an ad 70.

In an embodiment, by way of example only, the server can also create a structure that is linked to by a HTML reference. A code snippet can be displayed next to a playlist such that a user can cut and paste it into a web page for embedding a player. This player will then reference the playlist and use the thin slices as defined before.

### Back-End System

In an embodiment the backend system (for example element 10 of FIG. 1 and FIG. 2) includes those parts of a video search system that typically do not interact with a client and typically do not run in real time as a response to a query. This can include processes of crawling, media or metadata processing, indexing and caching of sliced videos required for the preview display.

The following provides example embodiments of specific components and functions of the Back End System.

### Crawling Video

Referring to FIG. 2, the crawler 2 does not directly take part in any client-server streaming scenario. The crawler is regularly run to find videos on the Internet and to gather information about them for entering into the index. Traditional web crawlers, as run by most of the major text search engines traverse the Internet by following links to other sites. See, for example, “The anatomy of a large-scale hypertextual Web search engine”, in Proceedings of WWW7, pages 107-117, 1998. As a crawler spiders the web, it can maintain a list of the sites that have been visited and on subsequent crawls this list or an existing index can be used to revisit known sites. When a crawler analyses the pages in the index, it will typically discover new sites, which have been linked to since the last crawl. In this way, new web pages can be discovered once linked to already known web pages.

Crawling for video type media can also be performed in a similar manner. A large-scale video media search engine can greatly benefit from having access to an existing index. Having an index of the textual web can be advantageous because semantic information about the video media can be inferred from the text that is positioned near to a video media link on a web page and from other web sites that link to the source of this video media. A major obstacle for video media crawling is that there is no guarantee that text surrounding the video media link is relevant to the video media data, and it would be appreciated that this is particularly true for video hosting sites.

The crawler is important for gathering a broad view of the media landscape on the Internet. In an embodiment, aside from the textual data, ranking information can be implied by the ranking information of the web page from which the media is linked. When the Internet is viewed as a directed graph, with the web objects, such as media files, web pages and images viewed as nodes, and with links as edges pointing to other web objects, items such as video media, audio media and images are generally effectively dead ends, with links only pointing in and not out. There are very few media formats that are an exception to this rule, in particular Annodex (see www.annodex.net).

Because video media is only loosely integrated with the rest of the web, simple generic crawling techniques are often not effective. A crawler specifically developed to target particular video hosting sites is disclosed. Although the textual information is still only loosely integrated with the media, in this case a page typically has a known layout. This can allow a crawler to gather specific pieces of textual metadata about the video media, such as author, title, duration, description etc. This type of crawling allows the crawler to gather much more specific information without having to guess the relationship of the text on the web page to the media file.

In another embodiment, when the media site provides a developer API (Application Programming Interface), a crawler can explicitly request information about the media in a known format, for example Extensible Markup Language (XML). It would be appreciated that this approach can be more efficient for both the crawler and the video media site as the information is typically in a compact form for providing specific information, rather than crawling a web page which may contain other extraneous information that is also downloaded (since this information is required for web browsers to view the page). In this embodiment the crawler can request information directly from a hosting site. An API can also simplify the development of a crawler because the format of any provided information can be specified.

It would be appreciated that crawling sites that do not have an API can be more CPU intensive and consume more bandwidth because there is a requirement to scanning through each web page for specific data, which can be in different places for each web page or request. In this case, crawlers can rely on a web page remaining in roughly the same layout, although not an identical layout. Major layout changes to a website typically necessitate that the crawler for that site is modified or rewritten. It is advantageous for crawlers to include mechanisms for detecting when a web page layout changes.

It would be appreciated that many video media files can contain small amounts of textual metadata, for example title or creator information. However this is much more common with audio and music files than with video files. Aside from the textual data, there is some metadata about the media itself, such as file format, resolution, bit rate, codecs, frame rate, sampling rate. For many file formats this information is found in a known location (usually the start of a file) and can be accessed by downloading a small portion of the file, without the need to download the entire media file. This metadata is the most reliable metadata that is available for media files and is typically required for indexing.

### Video Cache

It is preferable to keep a copy of all video data that have been visited. It would be appreciated that this can enable smooth playback of preview streams or further content analysis, where further content analysis can include colour profiling of the videos to identify duplicates, speech recognition to extend the set of annotations, or transcoding to one particular format.

It would be appreciated that unless video data at a hosting site provides a means to extract video snippets at random offsets from the hosted content, to extract a relevant thin slice of video data it is preferable to cache the complete video data.

By way of example only, for short duration video data, the first 20 to 30 seconds typically contains enough representative material. In an embodiment it may be unnecessary to keep a full copy of these short duration video data. If content analysis is required, the analysis can be performed and the copy eliminated, thus retaining only the indexing information. For the purposes of playback, only thin slices of the video may be required. Similarly, a representative video thumbnail image can be retrieved from metadata located during crawling and this image saved in a cache.

### Index Construction

As a list of video data published on a video hosting site is not generally available, a task of a crawler is to find and store references to videos on hosting sites. Approaches to find videos can vary, along with the amount of metadata retrieved, depending on the video hosting site. Two approaches of finding video data include: using an API provided by the hosting site, and exploiting other aspects of the Web interface of the hosting site.

For hosting sites that provide an API, the crawler can take advantage of specific methods offered in the API. These methods typically rely on a tag to be provided that identifies which videos will be returned. Part of the metadata attached to each of the returned videos can include additional tags that were specified by the user at the time of uploading the video. This functionality can be used to create a “tag crawler”.

Metadata from a video hosting site generally contains user provided tags, which attempt to categorise videos into one or more loosely defined categories. Because each video can contain multiple tags, a simple recursive tag crawling approach can be taken.

In an embodiment, by way of example only, a method of “crawling” can include the steps of:
(a) Providing a starting set of a few hundred words expected to be popular tags, augmented by dictionary word lists of English words, places and names, which are input into the crawler manually and are stored in a database for future iterations.
(b) Requesting a list of videos that have those tags stored in the database.
(c) Generating a new set of tags by creating a new list of all the other tags provided in each of the listed videos.
(d) Adding the new set of tags to the database.
(e) Reiterating steps (b) and (c) using the new set of tags stored in the database as input into the crawler for the next iteration of searching.

Each iteration of the Crawler, unused tags are selected from the whole set of tags stored in the database to further identify video data and marks containing these tags. The Crawler can discover new videos as the set of tags stored in the database becomes larger, preferably until substantially all the tags in the hosting site are included in that set and all the available videos are identified.

This process can be represented through the following formula:

T₀={tₓ,t_{y},t_{z},K}

Tₙ=Tₙ₌₁∪{tᵢ:∃vⱼ where (vⱼ→tₖ)̂(vⱼ→tᵢ)̂tₖεTₙ₌₁}

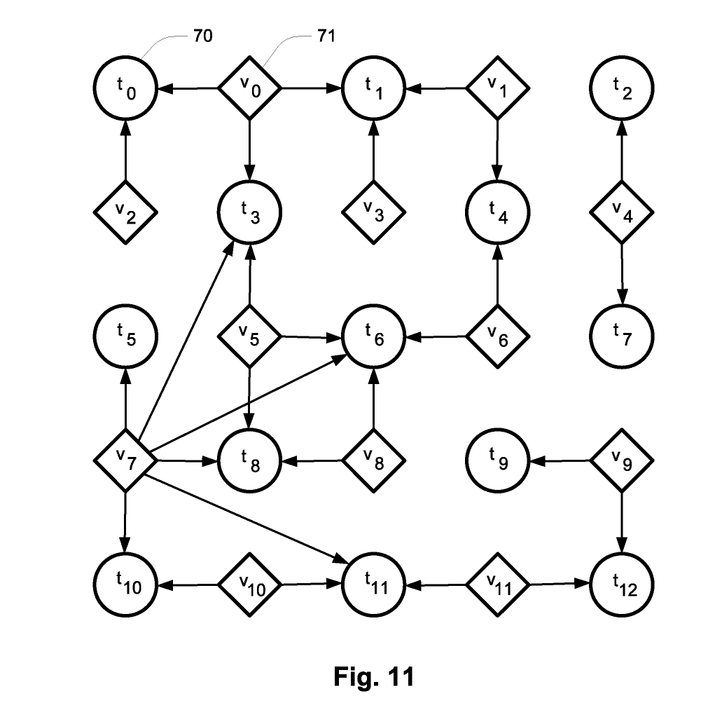

Referring to FIG. 11, an example series of crawler iterations are provided where:

| Iteration | Set of tags | Comments |
|---|---|---|
| 0 | T₀ = {t₀, t₁} | Initial tag set |
| 1 | T₁ = {t₀, t₁, t₃, t₄} | Tag set after one |
| | | iteration |
| 2 | T₂ = {t₀, t₁, t₃, t₄, t₅, t₆, t₈, t₁₀, t₁₁} | Tag set after two |
| | | iterations |
| 3 | T₃ = {t₀, t₁, t₃, t₄, t₅, t₆, t₈, t₁₀, t₁₁, t₁₂} | Tag set after three |
| | | iterations |
| 4 | T₄ = {t₀, t₁, t₃, t₄, t₅, t₆, t₈, t₉, t₁₀, t₁₁, t₁₂} | Tag set after four |
| | | iterations |

Referring to FIG. 11, each circle icon (for example 70) represents a tag and each diamond icon (for example 71) represents a video. It would be appreciated that, in general, Tₙ is the tag set after the crawler has performed n iterations. Further, tᵢ is a tag, vⱼ is a video, and an arrow between a video and a tag signifies that that video has been marked with that tag. Although videos that are not part of the graph built by tags and videos will not be found, these videos may eventually be discovered through an extension of the tag collection from other video hosting sites.

In this example, T₀ is the initial tag set which includes the tags t₀ and t₁. After the first iteration the sag set T₁ includes the tags t₀, t₁, t₃ and t₄, as these are associated with videos (v₀, v₁, v₂ and v₃) that contain the initial tag (t₀ and t₁). Based on tag set T₁, these tags are associated with videos v₀, v₁, v₂, v₃, v₅, v₆, and v₇. On the next iteration this provides a tag set T₂ includes the tags t₀, t₁, t₃, t₄, t₅, t₆, t₈, t₁₀ and t₁₁. Other iterations are indicated in the table above. It would be appreciated that based on the initial tag set video v₄ cannot be identified.

In an example, the algorithm accesses the tags on a hosting site through a spanning tree mechanism. In each iteration, as more tags are searched, the number of new tags found will begin to decrease as the total number of known tags approaches the number of tags available on the site. Similarly, as more of the tags are searched, the number of new videos found will begin to decrease due to an increasing number of videos being identified in previous iterations. It would be appreciated that by analysing the rate at which new videos are being identified the total number of videos on the site can be estimated.

An example method can enable a crawler to focus on sites that are more likely to provide the most new content. As a crawler continues to iterate over a video hosting site, at some iteration very few new videos will be identified in successive iterations. It would be appreciated that later maintenance crawls may be appropriate for checking changes or additions to already known videos or tags.

For hosting sites that do not provide an API, the crawler can exploit different aspects of an associated Web interface.

In one embodiment, a crawler can analyse video index pages that are intended for users. This can enable the crawler to identify a number of videos that are referenced on those index pages. The crawler can interact with the hosting site until it arrives at a final index page.

It would be appreciated that in cases where a hosting site provides a search box, the crawler can use a set of tags to perform searches and collect the video metadata from resulting Web pages or search results. This process can be initiated with all tags a crawler had previously identified, where the crawler queries a hosting site search in a similar way to a user searching for a word or words. Search results can then be analysed and indexed. Similarly to the method described above for indexing sited that provide an API, the title and description elements of newly identified videos metadata can be tokenised for creating new tags added to the database, and used in subsequent iterations of the crawler.

In an embodiment, a smart staggered re-crawling approach can be used, whereby newly identified videos are reviewed more frequently than older videos. This approach is suitable where changes occur more often to recently uploaded videos than older video content. In this embodiment, re-crawling decreases in frequency over time.

In an embodiment, retrieved metadata elements of newly identified videos can be inserted into a video database. Those metadata elements that indicate video metrics such as view count, rating, comment count, rating count, etc are stored incrementally in the database, thus creating a history related to each video. Newly identified videos can have a metadata item set, to a predetermined value to indicate this status.

### Indexing System

The indexing system holds metadata information about identified media, which is typically gathered by one or more crawlers. The indexing system typically consists of a metadata repository and a relevance-ranked index, which enables fast query processing. It would be appreciated that the indexing system is typically called via the scripting engine to service search requests.

By way of example only, the following list provides an overview of the data created by a crawler and processing undertaken by an indexer to create a repository with information related to the crawled videos (in preparation for retrieval).
Raw crawl data—Each crawler typically downloads a large amount of raw data. By way of example, the information includes HTML pages and XML.
Id Lists—An indexer operates on the raw crawl data to generate a list of unique document id's. To facilitate faster indexing, this list of id's can be stored in a docid file. This file can be passed to a crawler to exclude identified videos that have already been indexed. This list can also used in deciding which videos are added to a relevance-ranked index.
Current search lists—This list can represents tags or search terms that have previously been used to search a hosting site. This list can also be used during data processing to exclude files from processing, such that only newly identified files are processed. This can represent terms in the seed list that have been already used.
Seed lists—A seed list is typically a list of words, names, places or search terms, which are used to search hosting site for videos. Each video on a hosting site can have multiple tags. Whenever a video is identified, all the other tags associated to that video, not already in the seed list, can be added to the seed list. The seed list can be augmented, for example by a word list, dictionary, or lists of common names etc. Further processing of the crawl data can be used to evaluate which terms in a seed list yield a larger amount of video and which few or none. This can be used to order the seed list, so that higher value terms are used first when a new site is crawled.
SQL inserts—From the raw crawl data a set of insert statements can be stored in a file for later addition to the relevance-ranked index.

Indexing an information repository (or database) that stores material found by the crawler, typically requires the formation of an inverted index structure.

In an embodiment, data stored within an index database (for example element 5 of FIGS. 1 and 2) can include the following.

| Field | Type | Attributes | Default |
|---|---|---|---|
| docid | bigint(20) | UNSIGNED | |
| title | varchar(255) | | |
| bitrate | int(10) | UNSIGNED | 0 |
| Filesize | bigint(20) | UNSIGNED | 0 |
| Filename | varchar(255) | | |
| Duration | int(10) | UNSIGNED | 0 |
| thumbfilename | varchar(8192) | | |
| description | text | | NULL |
| vidheight | int(10) | UNSIGNED | 0 |
| Vidwidth | int(10) | UNSIGNED | 0 |
| vidframerate | int(10) | UNSIGNED | 0 |
| audsamplerate | int(10) | UNSIGNED | 0 |
| audnumchannels | int(10) | UNSIGNED | 0 |
| audsamplewidth | int(10) | UNSIGNED | 0 |
| hasaudio | tinyint(1) | | 0 |
| hasvideo | tinyint(1) | | 0 |
| contentsource | int(10) | UNSIGNED | 0 |
| videoformat | varchar(128) | | |
| sourcepage | varchar(8192) | | |
| sourcehost | varchar(8192) | | |

This table displays an example set of index data extracted about each video during a crawl. The title and description fields are the fields in which textual annotations can be stored. Further fields can be populated for adding tags and other metadata. It would be appreciated that this table can be used for retrieval.

### Summary of the Workflow for Crawling and Indexing

In an embodiment, crawling and indexing workflow can be summarised in the following steps:
If there is existing crawl data, generating a current search list for use as a initial tag set.
Generating a docid list from a repository for determining which video id's are in the repository.
Using an initial tag set (or seed list) and a current search list for creating a potential term list to determine which terms are processed next.
If desired, splitting the potential term list into multiple parts for performing a search on multiple machines.
Initiating a crawl by giving a crawler a location for the raw crawl data and the potential term list.
Generating raw crawl data.
Processing the raw crawl data to generate insert statements for an index. It would be appreciated that this can require providing the location of the raw crawl data, the previous current term list (these files if they exist will be excluded from processing), the previous docid list (docids in this list will be excluding from processing), and an output filename.

### Query & Retrieval

Referring to FIG. 2, the real-time phase 11 can include a user submitting a query 20 (including possible validation of the query string), processing the query by matching the query terms with the data in the index and ranking results 21, for creating a search result list.

In an embodiment a query can be validated against a dictionary or compared to previous search queries. By way of example only, a query engine can propose spelling corrections or alternative search terms.

Processing a query includes matching query search terms against an index. Data indicative of videos whose annotations contain one or more of the query terms are retrieved. Since the index includes fundamental information about videos, the index can contain videos in a pre-ranked order, which can be used in determine the relevance of a video. The more highly pre-ranked videos can be retrieved until a predetermined number of videos that satisfy the query is reached. For example, this typically amounts to no more than a few hundred videos.

In an embodiment, by way of example only, duplicates are preferably not added and thereby have only one aggregate entry in the index. Therefore each retrieved “video” can be indicative of several separate duplicate videos each having separate annotations. These separate annotations can be aggregated to form an aggregate annotation to provide the index with information associated with the single retrieved “video”.

It would be appreciated that a plurality of ranking schemes are possible. In one scheme, by way of example only, the ranking of retrieved videos can make use of the ‘location’ of the queried terms, which can include:
Weighting the number of query terms that are included in a video annotation toward a higher the ranking of that video;
Weighting the relative location of query terms that are included in a video annotation toward a higher the ranking of that video;
Weighting the frequency of occurrence of query terms that are included in a video annotation toward a higher the ranking of that video;
Weighting the functional location of query terms that are included in a video annotation toward a higher the ranking of that video (for example this can include if the query term is located in the title or author);

In an embodiment, a post-retrieval process can include one or more of the following:
composing the search results for presentation to a user;
composing the search results for creating a result list, which can be in the form of an XML file and represent a slicecast; and
Filtering out specific information, which can include videos identified as adult or other inappropriate content.

In an embodiment, a post-retrieval process can include retrieving one or more video advertisement based on information about the query and/or about the user. These advertisements can be retrieved automatically from a collection of advertisements. These advertisements can be presented to the user as part of a search results. It would be appreciated that further types of advertisements, including logos (bugs), brand representations, audio, images and text may also be retrieved an incorporated into the slicecast. Search results can be composed for presentation into a search result list, which can be represented in a number of forms including a table, and a slicecast.

Identifying duplicates and aggregating search results can require video analysis. In an embodiment, this analysis can be provided through a video indexing service. The video indexing service can scan video files and creates an index for each frame. This frame index has multiple parts and includes components indicative of a colour histogram, image segmentation and an audio histogram.

This video indexing service can provide an index of video frames, which can be searched in a number of ways and under numerous criteria. For examples, a search can include:
searching for a 100% frame and audio match to a selected clip can identify a duplicate clips;
searching for a 100% frame match and a 100% audio mismatch to a selected clip can identify a duplicate clips that has an alternate sound track;
Search for a 100% audio match and a 100% frame mismatch to a selected clip can identify a clip that has a common audio track.

It would be appreciated that these searches could similarly be performed with other percentage matches or mismatches, for example:
searching for a clip that has a 10% frame and audio match to a selected clip, for identify a clip that has a common section of the selected clip.
searching for a clip that has a 10% audio match to a selected clip, for identifying a clip that has a common section of the selected clip's audio.
searching for a clip that has a 10% frame match to a selected clip, for identifying a clip that has a common section of the selected clip's video.
searching for a clip having a single frame in common with a selected clip using all the sub indexes but excluding the audio, or identifying a clip that has a common frame to the selected clip.

In an embodiment, a search interface can allow a user to browse clips and select the search parameters. For example, whether a percentage of a clip to search for, whether audio and or image match is required or whether a single frame of a clip is required. A user can elect to search using a colour histogram and or segmentation indexes. A user can also select whether the frames in common must be contiguous or not. Searches can also be saved for reuse later. It would be appreciated that other search options are possible.

Video indexing can, for example, be used for searches including one or more of the following:
searching for mashed-up clips containing parts of a clip of interest, whereby a whole video clip can be searched for to return clips that contain frames in common with it;
for mashed up clips containing parts of a clip of interest, whereby multiple contiguous frames are in common;
searching for a logo, whereby the index of a frame containing the logo is saved as a search which can be used to search for that logo in all indexed videos.
searching for a jingle, whereby a segment of video containing the required jingle can be searched for, to return multiple contiguous frames matching the audio component of this index.

Video indexing can, for example, be used for metrics including one or more of the following:
aggregating video use measurements for videos that have been identified as duplicates;
aggregating video use measurements for videos that have been identified as mash-ups of the same video; and
providing video use measurements for videos that contain the same logo or jingle.

### Slicecasts/Playlists

It would be appreciation that searching can also be a process for creating embeddable slicecasts. Videos for embeddable slicecast can originate from a search, or can alternatively be collected through a different mechanism of identifying video content such as cutting and pasting of a Uniform Resource Locator (URL).

Content of a slicecast can be composed by a professional editor or by a user with access to an appropriate slicecast authoring environment. An example of a suitable environment is illustrated in FIG. 8.

A slicecast authoring and management infrastructure can allow for control over the content and the consistency of slicecasts. An alternate method for creating a slicecast is a fully automatic creation where clips are extracted from a collection using an appropriate algorithm, e.g. a slicecast updated with the latest clips added to a collection.

Slicecasts can be created as a volatile product—i.e. they exist only for the duration of one particular use—or as persistent products—i.e. they are attributed to a user and remain in existence until deleted or removed.

It is preferable that persistent slicecasts conform to a specification such that they can be shared between users for further services. By way of example, this specification can represent the slicecast as a XML document.

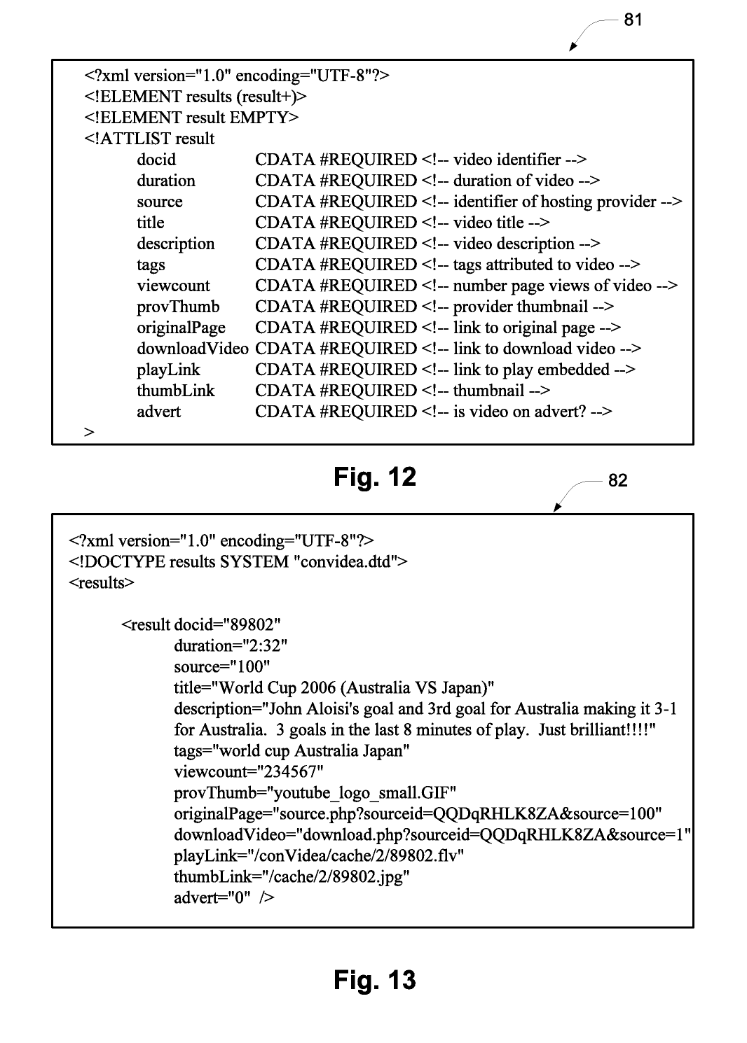

Referring to FIG. 12, an example Document Type Definition (DTD) specification is shown for a persistent slicecasts. It would be appreciated that alternative representation include an iTunes RSS feed, a mediaRSS feed, or Continuous Media Markup Language (CMML). This specification also represents information typically required in a database for representing a slicecast.

Referring to FIG. 13, an example XML file is shown for representing one search result. It will be appreciated that a URL can be hidden within scripts, which makes it possible to retain logs of user interactions with the playlist and/or slicecast.

### Functionality of the Playback Interface

A video playback interface typically provides for the playback of playlists/slicecasts. It preferably allows for the smooth playback of videos and simple control of a collection of thin video slices that it controls. FIG. 6 illustrates an example interface where a current video 51 is played with controls 56 and a series of videos e.g. 52-54 are played back simultaneously or in freeze frame for the user to access.

In this embodiment, a playback interface receives an XML playlist/slicecast input that includes links representing thin video slices and their associated metadata. This XML list contains the information required for the user interface and links (typically in the form of Uniform Resource Locators or URLs) to where the videos can be found.

This player has a video playback space 51, where the thin video slices are played back. Each thin slice plays for 5-12 sec before stopping and “wiping out” to the left and the next video slice “wipes in” from the right, preferably with some black space in between. The next video slice starts playing as soon as it fills the playback space and buffering is complete. Each of the videos is preferably overlaid with the logo of the hosting site from which it originated. A user can click on the playing video, the video can be selected and the user is linked to a page of the original hosting site. The space 58 to the right of the video is text space that can contains information (for example metadata and annotations) about the current video This information can include title, description, duration and a link to the original video. A preview bar for the thin video slices 52-54 to come is also provided, and consists of key frames (images) of the currently playing thin slice plus key frames of the next few (for example four) thin slices on the playback list. This is a sliding window of the next few thin slices. As the current video finishes playback and “wipes out” to the left, its key frame also “wipes out” to the left and all the other key frames shuffle left. The preview bar can allow direct navigation to one of the thin video slices in the playlist, for example as a user clicks on or selects one of the key frames, the video playback stops and the selected video is played.

In an embodiment, the video player can be an embeddable player. The HTML code required to embed the player in a different Website is displayed to allow cutting and pasting the relevant code.

### Video Search in Advertising

Within a given user interface for video search, many new formats for advertising are possible. In an embodiment, the creation of “real estate” for video advertising can be a key functionality of the player.

It would be appreciated that advertisements can be video clips, audio clips, audio clips with a static image, so-called “bugs” (i.e. icon-size advertisement symbols) which can be static or moving, images, or a short piece of text. Each one of these formats can be incorporated into the video preview or slicecast player to create advertising. Advertisements can also be extracted from a collection based on the query that the user poses and based on any other knowledge that is available about the user, e.g. their GPS location, their gender, their age. This is in particular possible for people that have signed up for a richer service. Advertisements can also have a hyperlink associated with them, which takes the user to a pre-determined web resource, to e.g. undertake a purchase action. There may even be several hyperlinks associated with one advertisement in a temporally or spatially non-overlapping means. These define what is called “hotspots”, which can be activated by the user.

Different locations can be used for incorporating advertisements within slicecast. For example, advertisements can be integrated into an excerpt stream at the beginning of a stream (e.g. as pre-roll), inside a stream as a separate content objects (e.g. interstitials every 10 search results), on transition between content objects (e.g. a piece of text on the black space that is displayed between two search results), superimposed on top of the content objects themselves (e.g. a bug in a corner of the content). It would be appreciated that superimposition on a content object can include static or moving superposition, may be on a transparent or solid background, may be expandable, floating, pop-up, and/or formatted. Advertisements can be integrated into the system at the time of a click-through to the retrieved content object. This will preferably require short clips (audio/video/image/text) that simply bridge the time gap created when loading the next page/video.

Referring to FIG. 7, example advertising is shown where a video advertisement 70 is inserted into the slicecast. As the slicecast is played through the preview list. A border around the advertisement can be used to mark that a clip has been sponsored.

It would be appreciated that video advertisements can be regarded like any other video content and for example be introduced into the stream at their natural ranking position during a search & retrieval process.

In an alternative embodiment, two slicecasts can be created from a search result: one containing video content search results and the other containing ad results (e.g. an “adcast”). The search results will be displayed by default, but this can changed to display the advertisements. It would be appreciated that an advertisement can stay on screen as an image for provide brand marketing even if the full duration of the advertisement is not viewed.

In an embodiment, an advertisement can be introduced into the key frame preview stream that represents the excerpt stream. This is typically restricted to images or text which work like banner advertisements. They are selectable for leading a user to a Website. These advertisements do not represent a video clip in the excerpt stream and can be simply skipped when the slicecast current play location gets to their position. These advertisements typically provide for a brand impression.

### Statistics and Analysis

Analysis of video use can consist of measuring direct user interaction with a piece of video content. Metrics refer to the analysis of the audience and general interaction statistics of video collections or aggregations without identifying individuals.

Measuring video/audio use or video/audio advertisement use can create the following analytics:
View count: how many people started viewing the video;
Completeness count: how many people watched the video in its entirety;
Average view duration: what was the average view duration, and the standard deviation from it; and
Click count: how many people clicked on the video.

Statistics of aggregate video use and audience interaction can include the following metrics:
Multiplicity measurement: How often a video has been published and to which social video sites. This indicator requires implementation of a duplicate identification approach. Since different social video sites compress video in different ways, sometimes using different variations of codecs, and since authors may upload them with diverse metadata, identification of copies is non-trivial. Auto-visual signal analysis algorithms can be used to construct unique fingerprints and signal profiles of videos enabling the identification of duplicates. This can form the basis for improved reporting on individual videos' quantitative metrics such as view count and number of comments. These can be aggregated across multiple instances of a piece of content.
By way of example only, the multiplicity measure can be represented by the following formula where vₓ(i) is a video on site x, vₓ(j), v_{y}(k), v_{z}(l) are videos from sites x, y and z respectively, and

d(vₓ(i),vₓ(i))<ε̂d(vₓ(i),vₓ(j))<ε̂d(vₓ(i),v_{y}(k))<ε̂d(vₓ(i),v_{z}(l))<ε,

then,

mm(vₓ(i))=∥M(vₓ(i))∥=∥{v:d(vₓ(i),v)<ε}∥
This multiplicity measure of vₓ(i) is the cardinality of the set created by videos that are less than ε different from vₓ(i). In this example mm(vₓ(i))=4.
Volume measurement: Measures the interest for a piece of content. This is a measurement of the change in number of views, both aggregate and differential. It typically measures views, comments, ratings, and video replies for instances of duplicate videos. It is best displayed in graph form over time and requires frequent measurements.
By way of example, an aggregate view count can be calculated by the following formula:

$$vc ( {v}_{x} ( i ) ) = {\sum }_{v ∈ M ( {v}_{x} i ) )} V ( v )$$

where V(v) is the view count of video v. To arrive at the view volume of day t, the following formula can be used:

$$vv ( {v}_{x} ( i ) ) = {\sum }_{v ∈ M ( {v}_{x} i ) )} ( V ( v , t ) - V ( v , t - 1 ) )$$

where V(v,t) is the view count of video v on day t. It would be appreciated that comments, ratings, and video reply volumes can be calculated analogously.
Virality indicator: Is a measure of whether a video is “going viral”. This indicator requires a statistical analysis of the rate at which the volume measurements increase, i.e. when the volume of access accelerates at a rate that is outside of the norm. The ability to determine that a video is going “viral” can be important.
In an embodiment, by way of example only, a virality indicator can be calculated by first determining the logarithmic differential time series on an indicator such as the view count (e.g. Yᵥ(t)=log(V(v,t)−V(v,t−1))) and performing a trend analysis on this series for predicting the next value Y̅ᵥ(t+1). The virality indicator is then calculated as:

vir(t+1)=(Yᵥ(t+1)− Y̅ᵥ(t+1)).
Spread rank: A measure of how well a video is spread over the Internet. In addition to being uploaded to multiple sites, social videos have the distinction of being able to be easily embedded, i.e. they are easily incorporated as content on Web properties that do not belong to the video hosting site. Some videos are only uploaded once, but embedded millions of times and are thus spread vastly across the Internet. Information gained from a full Web search provider can be combined with its locally generated information about videos to create statistics on the embedding of videos and calculate a spread rank for videos. By setting S=max(E(v)), where E(v) is the number of embeddings for video v. In an embodiment, by way of example only, a spread rank rank of video vₓ(i) can be calculated as follows:

$$sr ( {v}_{x} ( i ) ) = \frac{E ( {v}_{x} ( i ) )}{S} .$$

Geographical reach: A measure of how well a video is spread over different geographical areas. Additional information gained from the Web search provider about the geographical location of the embeddings will provide the basis for a calculation of parochial impact of a video.
For example, geographical reach can compare the spread in the USA to the spread in Australia for a certain video E(vₓ(i)). It would be appreciated that geographical reach can be calculated by first separating the embeddings based on geographical identification of the IP addresses of the embedding sites and then comparing E(vₓ(i),IP_{USA}) to E(vₓ(i),IP_{AU}).
Controversy indicator: A measure of how much controversy a video creates. If a video is controversial, the online community tends to rapidly and massively respond through ratings, comments and video replies. The sheer measurement of the number of comments and video replies, as well as the variance in rating values can provide good indicators for how controversial a public piece of video is. Controversy flags videos that need to be treated specially, and potentially be delivered to clients in video alerts. It also helps flags videos that may go viral. Frequent data gathering as well as a sound statistical approach are again significant to calculate this indicator. It also should be noted that in many instances the controversy and impact of a video may not be directly proportional to its number of views.
In an embodiment, by way of example only, a controversy indicator can be calculated for a video vₓ(i) as a combination of the ratings volume rv(vₓ(i)), the comments volume cv(vₓ(i)), the video replies volume vrv(vₓ(i)) and the variance in ratings

$${var}_{r} ( {v}_{x} ( i ) ) = {\sum }_{i = 1}^{n} {( {R}_{{v}_{x} ( i )} ( j ) - {\overline{R}}_{{v}_{x} ( i )} )}^{2} with {\overline{R}}_{{v}_{x} ( i )} = {\sum }_{j = 1}^{n} {R}_{{v}_{x} ( i )} ( j ) .$$

Attractiveness indicator: A measure of how popular the video is. “Good” videos (for some subjective measure of quality) attract a large online audience willing to provide positive ratings. Thus, a statistical analysis of frequent rating measurements as to the average rating and its variance should provide good metrics for an attractiveness indication. Going further, it may even indicate what sentiment a video presents—lots of high ratings indicate positive sentiment and good quality video, lots of low ratings negative sentiment and poor quality video. In an embodiment, by way of example only, an average rating can be calculated from the submitted ratings rᵢ as

$$\overline{r} ( n ) = \frac{1}{n} {\sum }_{i = 1}^{n} {r}_{i} .$$

In this embodiment, the variance on the ratings can be calculated as

$$v ( n ) = \frac{1}{n} {\sum }_{i = 1}^{n} {( {r}_{i} - \overline{r} ( n ) )}^{2} .$$

It would be appreciated that when the average rating is larger than a threshold r̅(n)>Tᵣ, and the variance of the ratings is relatively low v(n)<ε, the video can be considered relatively attractive.
Relevance rank: A measure of how relevant a video is to a particular topic. Capabilities in video indexing and search enable the calculation of a rank for a particular video in referencing a specific topic. This enables filtering the delivery of information to clients, who generally are interested in specific topics. Relevance ranking provides them with an indicator about the importance of a video to their areas of interest.
Influence indicator: A measure of how influential a video is. This is an aggregate indicator, which can be calculated by statistical integration of several of the other indicators, such as the volume indicators, the controversy indicator, and the geographical reach. Care must be taken to handle the statistical dependence of these variables.

A preferred embodiment also provides an effective video-searching and sifting interface. This preferred embodiment, by way of example only, includes a system for collecting videos, an indexing system and a user interface system for querying the index and displaying the results for interrogation by a user. The interface includes the display of a video playlist and the construction of the video playlist through a thin slicing process with hyperlinks (i.e. interactive video links) behind the videos.

In an embodiment, several audio-visual content analysis algorithms create thin slicing, for most videos this is typically fixed to use of the first 5-12 of seconds. Alternatively this can include skipping of a non-unique introduction, skipping of silence and black frames, skipping of titles, and the use of audio blending to gain a less disruptive slice.

This thin slicing process can also includes the addition of video advertisements at frequent positions in the preview stream, which demonstrates how the consumer will view the thin slice video preview stream, including the advertisement and allows to embed them into other video pages, demonstrating the socialization factor of the preferred embodiment.

As part of the user interface, there are diverse means for inserting advertising into the presented video playlist. By way of example these can include: icon overlays, bugs, banner overlays, audio advertisements and video advertisements.

Embodiments can also consist of measuring and analysing user interaction with aggregated videos. Clear information on the interaction of the user with the video is necessary to provide a valuation for advertising opportunity. It can also provide further input to the ranking of video in search results.

Another aspect to the present invention can include predictive metrics that provide searchers with recommendations of potentially relevance to them.

### Interpretation

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms. Modifications, obvious to those skilled in the art can be made thereto without departing from the scope of the invention.

We claim:

1. A video search method adapted to be queried by a user for accessing video data, the method comprising the steps of:
(a) providing an index containing a plurality of index data each indicative of one or more video data element accessible on a data network for defining a collection of said video data elements;
(b) receiving a user query from said user;
(c) matching said user query to one or more said index data defining a result set of index data;
(d) ranking said result set for defining a ranked result set of index data;
(e) generating a slicecast of video data elements indicative of said ranked result set; and
(f) presenting said slicecast to said user.

2. The method of claim 1, wherein said generating a slicecast includes the steps of
(a) creating for each video data element a video snippet of a predetermined length;
(b) ordering said video snippets into a first predetermined order associated with said ranked result set; and
(c) combining said ordered video snippets to form a slicecast.

3. The method of claim 2, wherein presenting said slicecast includes providing an interactive interface that includes the steps of:
(d) displaying a first section for images indicative of a predetermined number of said video snippets in said first predetermined order;
(e) displaying a second section for playing in turn said snippets from each of said video data elements indicative of said ranked result set.

4. The method of claim 2, wherein said video snippets are substantially 7 to 12 seconds long.

5. The method of claim 2, wherein said videos snippets are displayed in a click-through format.

6. The method of claim 2, further including the step of providing a HTML insertable object having the rendering characteristics of
(a) displaying a first section for images indicative of a predetermined number of said video snippets in said first predetermined order; and
(b) displaying a second section for playing in turn said snippets from each of said video data elements indicative of said ranked result set.

7. The method of claim 6, wherein as said second section plays a current video snippet, said first section displays images indicative of said video snippets before and after said current video snippet in said first predetermined order.

8. The method of claim 6, wherein said HTML insertable object includes said slicecast.

9. The method of claim 8, wherein said slicecast is in an XML format.

10. The method of claim 1, wherein said slicecast is pre-cached for presenting to said user.

11. The method of claim 1, wherein generating said slicecast includes inserting one or more advertising video elements.

12. The method of claim 1, wherein said videos elements further include advertisements in the form of at least one of icons, bugs, banner, audio or video advertisements.

13. The method of claim 1, wherein said providing an index includes the steps of:
(a) providing an tag set;
(b) searching a video host site for video elements associated with tags in said tag set;
(c) indexing videos elements returned by said host site.

14. The method of claim 13, wherein further including the steps of:
(d) interrogating video elements returned by said host site to identify additional tags associated with said video elements;
(e) adding additional tags to said tag set; and
(f) repeating steps (a) through (c).

15. The method of claim 13, wherein one or more advertising video elements are indexed.

16. A method of claim 1, wherein said ranking said result set includes ranking said video data based on any one or more indicator selected from the set comprising:
weighting the number of query terms that are included;
weighting the relative location of query terms that are included;
weighting the frequency of occurrence of query terms that are included; and
weighting the functional location of query terms that are included.

17. The method of claim 1, wherein said index includes data indicative of any one or more videos and their metrics selected from the set comprising:
view count;
completeness count;
average view duration; and
click count.

18. The method of claim 1, wherein said index includes data indicative of any one or more videos and their metrics elected from the set comprising:
multiplicity measurement;
volume measurement;
virality indicator;
spread rank;
geographical reach;
controversy indicator;
attractiveness indicator;
relevance rank; and
influence indicator.

19. A video search system adapted to be queried by a user for access to videos, the system comprising:
an index indicative of collected video elements;
a user interface associated with said index for providing keyword searching capabilities; said user interface adapted to present a slicecast of results;
said user interface further comprising a first current playlist video element area for playback of an extracted portion of a current playlist video item and a second list of playlist element area including a series of playlist videos for playback by a user.

20. The video search system of claim 19, further comprising a crawler adapted to retrieve and index video elements located on a data network.

21. The video search system of claim 20, wherein said crawler is further adapted to iteratively retrieve data elements from a host site on said data network.

22. A computer-readable carrier medium carrying a set of instructions that when executed by one or more processors cause the one or more processors to carry out a video search method adapted to be queried by a user for access to video data, the method comprising the steps of:
(a) providing an index containing a plurality of index data each indicative of one or more video data element accessible on a data network for defining a collection of video data elements;
(b) receiving a user query from said user;
(c) matching said user query to one or more said index data defining a result set of index data;
(d) ranking said result set for defining a ranked result set of index data;
(e) generating a slicecast of video data elements indicative of said ranked result set; and
(f) presenting said slicecast to said user.
